(19) United States
(12) Patent Application Publication
(10) Pub. No.: US 2026/0242620 A1
(43) Pub. Date: Aug. 20, 2026

(54) COATING COMPOSITIONS, NON-CONDUCTIVE COATINGS, NON-CONDUCTIVE FILMS, ARTICLES THEREOF, METHODS OF MANUFACTURE THEREOF, AND METHODS OF USE THEREO

(71) Applicant: PPG Industries Ohio, Inc., Cleveland, OH (US)

(72) Inventors: Scott Joseph Moravek, Mars, PA (US); Nicolas Benjamin Duarte, Allison Park, PA (US); David Leonardo Gonzalez Arellano, Colonia San Lorenzo (MX); Kevin Mark Valdisera, Pittsburgh, PA (US); Samuel Logan Esarey, Allison Park, PA (US)

(73) Assignee: PPG Industries Ohio, Inc., Cleveland, OH (US)

(21) Appl. No.: 19/161,397

(22) PCT Filed: Mar. 13, 2024
(86) PCT No.: PCT/US2024/019630

§ 371 Date: Sep. 2, 2025

Related U.S. Application Data
(60) Provisional application No. 63/489,858, filed on Mar. 13, 2023.

(51) Int. Cl. C09D 5/24; B05D 3/06; C09D 7/61

(52) U.S. Cl. CPC C09D 5/24; B05D 3/067; C09D 7/61; B05D 2502/00

(57) ABSTRACT

This invention deals with effect pigment mixture comprising platelet-like aluminum effect pigments obtained by grinding of aluminum or aluminum based alloy shot and silvery pearlescent pigmentₛ, wherein the silvery pearlescent pigments are taken from the group consisting of: a) pearlescent pigments comprising a transparent substrate which is coated with a high-refractive index layer with n>1.8, which comprises or consists of an iron-oxide with Fe(II)-ions, b) pearlescent pigments comprising a transparent substrate which is coated with a high-refractive index layer with n>1.8, which comprises or consists of titanium suboxide or a pearlescent pigment comprising a substrate with a high-refractive index with n>1.8 layer, which comprises or consists of a titanium suboxide that is optionally coated with a high-refractive index layer with n>1.8, c) pearlescent pigments comprising a transparent substrate which is coated with a high-refractive index layer with n>1.8, which comprises or consists of titanium oxynitride, d) pearlescent pigments comprising a transparent substrate which is coated with a layer comprising carbon, wherein the carbon is enclosed in a particulate form in another metal oxide layer or is formed as a separate, individual layer, e) a transparent substrate coated with a first layer comprising or consisting of a mixture of the oxides of titanium, iron and at least one of cobalt and chromium and a second layer on the first layer, wherein the second layer comprises an oxide of titanium, and mixtures or combinations of the pearlescent pigments a) to e) or pearlescent pigments with mixtures or combinations of the various coating layers mentioned in the pearlescent pigments a) to e), wherein the weight ratio of the pearlescent pigment to the aluminum effect pigment is in a range of 0.4 to 5.0. The invention deals also with a coating formulation containing this effect pigment mixture.

### FIELD

The present disclosure relates to coating compositions, non-conductive coatings, non-conductive films, articles thereof, methods of manufacture thereof, and methods of use thereof.

### BACKGROUND

The use of radar is becoming ubiquitous in modern transportation including passenger vehicles with advanced driver assistance systems (ADAS), such as adaptive cruise control (ACC), automatic breaking, and the like. The use of radar will likely increase as additional advances in autonomous driving are implemented. However, radar performance can be hindered by unwanted radar signal loss caused by a bumper or mirror housing that the radar may be positioned behind. Manufacturing systems and assemblies that minimize interference with radar can be challenging.

### SUMMARY

The present disclosure can include a coating composition which may include a film-forming resin and a conductive additive wherein a coating formed from the coating composition has an irreversible increase in resistivity of at least 20%, as measured with an ohm meter probe prior to and after exposing the coating to an external stimulus. In some aspectₛ, the coating formed from the coating composition has an irreversible increase in resistivity of at least 20%, at least 50%, at least 100%, at least 500%, at least 1,000%, at least 10,000%, at least 100,000%, or at least 300,000%, all as measured with an ohm meter probe prior to and after exposing the coating to an external stimulus.

The present disclosure also relates to a coating or film produced from curing a coating composition. The coating composition comprises a film-forming resin and a conductive additive. A coating formed from the coating composition has an irreversible increase in resistivity of at least 20%, at least 50%, at least 100%, at least 500%, at least 1,000%, at least 10,000%, at least 100,000%, or at least 300,000%, all as measured with a probe prior to and after exposing the coating to an external stimulus.

The present disclosure can also include an article which may include a substrate; and a non-conductive coating or non-conductive film formed over the substrate, wherein: the non-conductive coating or film comprises a film-forming resin and a conductive additive to which an external stimulus has applied; the non-conductive coating or non-conductive film transmits 20% or greater of electromagnetic radiation comprising a frequency of 1 GHz to 300 GHz through the coating or film. In some aspectₛ, the non-conductive coating or non-conductive film is produced by applying an external stimulus to a coating or film produced from curing a coating composition. The coating composition may in turn include a film-forming resin and a conductive additive. A coating formed from the coating composition may have an irreversible increase in resistivity of at least 20%, at least 50%, at least 100%, at least 500%, at least 1,000%, at least 10,000%, at least 100,000%, or at least 300,000%, all as measured with a probe prior to and after exposing the coating to an external stimulus.

The present disclosure can still further include a method for making an article, where

the method may include applying a coating composition over a substrate, wherein the coating comprises a film-forming resin and a conductive additive; curing and/or drying the coating composition on the substrate to form a self-supporting coating; and subjecting the self-supporting coating to an external stimulus to form a coating layer on the substrate; wherein the coating layer: is non-conductive and transmits 20% or greater of electromagnetic radiation comprising a frequency of 1 GHz to 100 GHz through the non-conductive coating. In some aspectₛ, the coating formed from the coating composition has an irreversible increase in resistivity of at least 20%, at least 50%, at least 100%, at least 500%, at least 1,000%, at least 10,000%, at least 100,000%, or at least 300,000%, all as measured with a probe prior to and after exposing the coating to an external stimulus. The method comprises drying and/or curing the coating composition on the substrate to form a self-supporting coating. The method comprises subjecting the self-supporting coating to an external stimulus to form a coating layer on the substrate.

The present disclosure also relates to a method for improving radio detection and ranging in an electromagnetic radiation frequency range of 1 GHz to 300 GHz, such as, 1 GHz to 100 GHz or 76 GHz to 81 GHz, with automotive radar sensors that are mounted behind coated articles. The method comprises applying a coating and/or film formed from a coating composition to an automotive substrate. The coating composition comprises a film-forming resin and a conductive additive. A coating formed from the coating composition has an irreversible increase in resistivity of at least 20%, at least 50%, at least 100%, at least 500%, at least 1,000%, at least 10,000%, at least 100,000%, or at least 300,000%, all as measured with a probe prior to and after exposing the coating to an external stimulus.

It is understood that this disclosure is not limited to the examples summarized in this summary. Various other aspects are described and excmplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a schematic view of a radar transmissive system according to the present disclosure.

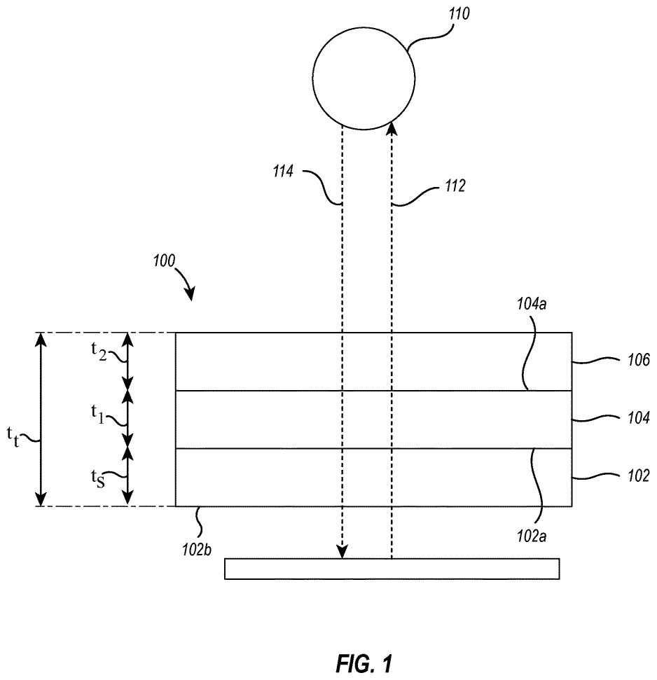

The excmplifications set out herein illustrate certain non-limiting embodimentₛ, in one form, and such excmplifications are not to be construed as limiting the scope of the appended claims in any manner.

### DETAILED DESCRIPTION

In many previous applications, a radar system was positioned behind a cover, such as a radome, a bumper, or a mirror housing to ensure desired aesthetics and/or protection for the radar system. However, radar performance can be hindered by unwanted radar signal loss, transmitted and received, caused by the cover, including coating layers of the cover.

The previous coating layers of the cover were applied by various methods, such as, for example, electrodeposition and electrostatic assisted application that utilize electrical charges to assist in deposition of a previous coating composition onto a substrate to form a previous coating layer. The substrate may be negatively charged and the previous coating composition may be positively charged such that the previous coating composition was attracted to the substrate and formed a uniform coating thereon. Some substrates may be non-conductive (e.g., non-conductive polymer-based substrates) and may require a previous electrically conductive coating to be first deposited onto the substrate prior to the electrodeposition process so that the negative charge can be formed using the previous electrically conductive coating. However, the previous electrically conductive coating can hinder radar transmission. To offset the radar signal loss, previous electrodeposition or electrostatic assisted application were avoided and/or a more powerful radar system may have been employed, that may result in increased manufacturing costₛ, a change in properties of the deposited coating, and/or size of the radar system.

The present disclosure provides coating compositions, non-conductive coatings, non-conductive films, articles thereof, methods of manufacture thereof, and methods of use thereof that can achieve desirable aesthetics, desirable manufacturing processes, and/or reduced radar transmission loss. For example, the coating compositions can be deposited onto a substrate and self-supporting to form a self-supporting coating and/or self-supporting film that has a first electrical resistivity suitable to assist in electrodeposition and/or electrostatic assisted application of a subsequent coating layer to form a coating system. The coating and/or film can be exposed to an external stimulus such that the first electrical resistivity irreversibly increases, thereby reducing radar transmission loss of the resulting coating system.

The coating composition according to the present disclosure comprises a film-forming resin and a conductive additive. The coating composition can form a coating and/or film suitable to assist in electrodeposition and/or electrostatic assisted application of a subsequent coating layer.

The coating composition can comprise an amount of the conductive additive suitable to form a coating having a first electrical resistivity suitable to assist in electrodeposition and/or electrostatic assisted application of the coating composition itself and/or a subsequent coating layer. The range for the first electrical resistivity can vary depending on the application and desired efficiency. The first electrical resistivity can be 30 ohm×cm or less, such as 25 ohm×cm or less, 20 ohm×cm or less, 15 ohm×cm or less, 10 ohm×cm or less, or 5 ohm×cm or less. The coating composition can comprise at least 0.01 wt % of the conductive additive, such as, for example, at least 0.1 wt %, at least 0.5 wt %, at least 1 wt %, at least 2 wt %, at least 5 wt %, or at least 10 wt %, all based on the total weight of the coating composition. The coating composition can comprise no greater than 30 wt % of the conductive additive, such as, for example, no greater than 20 wt %, no greater than 15 wt %, no greater than 10 wt %, no greater than 5 wt %, or no greater than 2 wt %, all based on the total weight of the coating composition. For example, the coating composition can comprise a range of 0.01 wt % to 30 wt % of the conductive additive, such as, for example, 0.1 wt % to 20 wt %, 0.5 wt % to 20 wt %, 1 wt % to 20 wt %, or 1 wt % to 10 wt %, all based on the total weight of the conductive additive.

The conductive additive can affect the electrical conductivity of the coating composition (e.g., increase the electrical conductivity of the coating composition in comparison to the same coating not comprising said additive). For example, the conductive additive can comprise carbon; a metal, in particular a conductive metal such as a metal alloy and a metal oxide; a conductive polymer, or a combination thereof. The carbon can comprise carbon black, carbon fibers, carbon nanotubes, graphene, or a combination thereof. The metal or metal alloy can comprise aluminum, an aluminum alloy, silver, a silver alloy, copper, a copper alloy, nickel, a nickel alloy, or a combination thereof (e.g, silver coated copper). The metal oxide can comprise indium tin oxide, nickel oxide, zinc oxide, chromium oxide, a doped version thereof, or a combination thereof. There are various dopants that may be used. For example, a dopant for zinc oxide is aluminum. The conductive polymer can comprise poly(3,4-ethylenedioxythiophene) polystyrene sulfonate (PDOT: PSS), polythiophene, polyaniline, polyphenylene oxide, polypyrrole, polyacetylene, or a combination thereof.

The coating composition can comprise an amount of the film-forming resin suitable to form a coating and/or film on the surface of the substrate. For example, the coating composition can comprise at least 20 wt % of the film-forming resin based on the total weight of the coating composition, such as, for example, at least 25 wt % or at least 30 wt %, all based on the total weight of the coating composition. The amount of the film-forming resin and/or conductive additive can be adjusted based on the desired application and presence of a solvent and/or other additives.

The film-forming resin can include a resin that can form a self-supporting (e.g., able to remain as a film of material with defined thickness, length and width and remains so without a supporting substrate being present) continuous film upon removal of any diluents or carriers during physical drying and/or cure at ambient or elevated temperature. “Film-forming resin” as used herein refers to resins that are self-crosslinking, resins that are crosslinked by reaction with a crosslinking agent, forming a solid film by solvent evaporation, mixtures thereof, or the like.

As used in this specification, the terms “cure” and “curing” refer to the chemical crosslinking of components in a coating composition applied as a layer over a substrate. Accordingly, the terms “cure” and “curing” do not encompass solely physical drying of coating compositions through solvent or carrier evaporation. In this regard, the term “cured,” as used in this specification, refers to the condition of a layer in which a component of the coating composition forming the layer has chemically reacted to form new covalent bonds in the layer (e.g., new covalent bonds formed between a binder resin and a curing agent).

The film-forming resin can comprise at least one of a thermosetting film-forming resin and/or a thermoplastic film-forming resin. As used herein, the term “thermosetting” refers to resins that “set” irreversibly upon curing or crosslinking, where the polymer chains of the polymeric components are joined together by covalent bonds, which are often induced, for example, by heat or radiation to form a three-dimensional network. Curing or a crosslinking reaction can be carried out under ambient conditions (e.g., ambient temperature and atmospheric pressure (e.g., 1 atmosphere)). Once cured or crosslinked, a thermosetting film-forming resin may not melt upon the application of heat and can be insoluble in conventional solvents (e.g., less than 0.001 g of the material can dissolve in 1 g of the given solvent at 20° C. after 24 hours). As used herein, the term “thermoplastic” refers to resins that include polymeric components that are not joined by covalent bonds to form a three-dimensional network and thereby can undergo liquid flow upon heating and are often soluble in conventional solvents (e.g., at least 0.1 g of the material can dissolve in 1 g of the given solvent at 20° C. after 24 hours).

The film-forming resin (e.g., in the example of a thermosetting coating composition) may further comprise a crosslinking agent such as, for example, an aminoplast, a polyisocyanate (including blocked isocyanates, and blocked polyisocyanates), a polyepoxide, a beta-hydroxyalkylamide, a polyacid, an anhydride, an organometallic acid-functional material, a polyamine, a polyamide, or a combination thereof.

A film-forming resin may have functional groups that are reactive with the crosslinking agent. The film-forming resin in the coating compositions described herein may be selected from any of a variety of polymers. The film-forming resin may comprise acrylic polymers, epoxy polymers, polyester polymers, polyurethane polymers, polyamide polymers, polyether polymers, polysiloxane polymers, copolymers thereof, or a combination thereof. The film-forming resin can comprise at least a 10-carbon chain backbone (e.g., at least 10 carbon atoms between ester linkages), such as, at least 12-carbon chains. Generally, these polymers may be any polymers of these types made by various methods.

The functional groups on the film-forming resin may be selected from any of a variety of reactive functional groups, including, for example, carboxylic acid groups, amine groups, epoxide groups, hydroxyl groups, thiol groups, carbamate groups, amide groups, urea groups, isocyanate groups (including blocked isocyanate groups), or a combination thereof. For example, the functional groups on the film-forming resin may comprise a hydroxyl group and a carboxylic acid group.

The coating composition can comprise a positive temperature coefficient (PTC) resin that changes its physical properties, namely its phase, shape, morphology, or a combination thereof, responsive to the external stimulus. The PTC resin can comprise 1,2-propylene glycol. The change in physical properties, i.e., The change in phase, shape, morphology, or a combination thereof, of the PTC resin can affect the electrical conductivity of a coating formed therefrom. For example, the PTC resin can be in a contracted state where an average distance between conductive particles is suitable to enable a desirable electrical resistivity of a coating formed therefrom. After subjecting the coating formed therefrom to an external stimulus, the PTC resin can be in an expanded state where the average distance between conductive particles is increased resulting in an increase in the electrically resistivity of a coating formed therefrom.

The PTC resin can be a polyester polymer that may include a backbone that comprises at least 10 consecutive carbon atoms between ester linkages (the count of consecutive carbons including the carbon forming a part of the ester linkage), such as at least 12, such as at least 14, at least 16, at least 18, or at least 20 consecutive carbon atoms between ester linkages. The backbone with the consecutive carbon chain may include a repeating carbon-containing unit, such as consecutive methylene groups. The backbone with the consecutive carbon chain may contain a mix of carbon-containing unitₛ, such as a mix of methylene and carbonyl groups.

The polyester polymer may include the following chemical structure:

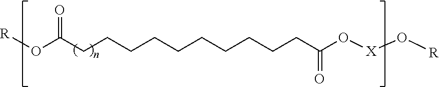

Where n≥1, X is incorporated through any polyol, and R is any component, including H.

The polyester polymer may include the following chemical structure:

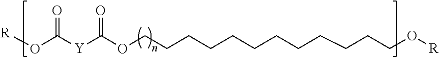

Where n≥1, Y is derived from any polyacid (including polyacid halide), polyester, or the like, and R is any component, including H.

The polyester polymer may have a linear structure. As used herein, the term “linear structure” refers to a straight chain polymer free of branches forming off of the straight chain. The polyester polymer may be substantially free of branching, such that the degree of branching of the polyester polymer is less than a level that would decrease the endotherm (glass transition endotherm or melting endotherm) by 50% compared to the completely linear polyester polymer. The glass transition endotherm and the melting endotherm are measured according to ASTM D3418. To determine the glass transition endotherm or the melting endotherm, a specimen of each sample was sealed in an aluminum hermetic pan and scanned twice in a TA INSTRUMENTS DISCOVERY DSC from-30 to 250° C. at 10° C./min. The DSC was calibrated with indium, tin and zinc standards and the nominal nitrogen purge rate was 50 ml/min. The half-height glass transition temperatures (Tg) were determined by two points and the peak areas were determined using a linear baseline.

The polyester polymer may include a non-aromatic polyester polymer. As used herein, the term “non-aromatic polyester polymer” refers to a polyester polymer free of aromatic groups. As used herein, the term “aromatic group” refers to a cyclic, planar molecule with a ring of resonance bonds that exhibits more stability than other geometric or connective arrangements with the same set of atoms.

The polyester polymer may include a saturated polyester polymer. As used herein, the term “saturated polyester polymer” refers to a polyester polymer in which all atoms are linked by single bonds, excluding the ester linkage. The polyester polymer may be an unsaturated polyester polymer having one or two degrees of unsaturation, excluding ester linkages.

The polyester polymer may include a semi-crystalline polyester polymer. As used herein, the term “semi-crystalline polyester polymer” refers to a polyester polymer containing both crystalline regions and amorphous regions.

The polyester polymer may include a bio-based polyester polymer. As used herein, the term “bio-based polyester polymer” refers to a polyester polymer prepared at least partially from bio-based monomers. The polyester polymer may be prepared using a diacid monomer, which diacid monomer may be derived from plant or vegetable oil. The polyester polymer may be prepared using a polyol derived from plant or vegetable oil. The polyester polymer may be prepared using glycerin as the polyol.

The polyester polymer may be prepared from a reaction of a polyacid component and/or a polyester component with a polyol component. The polyacid component may include a diacid monomer. The polyacid component may include a polyacid halide. The polyester component may include a diester monomer.

As used herein, the term “polyacid” refers to a compound having two or more acid or acid equivalent groups (or combination thereof) and includes the ester and or anhydride of the acid. By “acid equivalent groups”, it means that the non-double bonded oxygen in the acid group has been substituted with another component, such as a halide component. Thus, the polyacid may include a polyacid halide or other polyacid equivalent. “Diacid” refers to a compound having two acid groups and includes the ester and or anhydride of the diacid. As used herein, the term “polyester” refers to a compound having two or more ester groups. “Diester” refers to a compound having two ester groups. As used herein, the term “polyol” refers to a compound having two or more hydroxyl groups.

The polyester polymer may be a reaction product of a polyol with a polyacid (e.g., a diacid) including an at least 10 consecutive carbon atom chain, such as at least 12, such as an at least 14, at least 16, at least 18, or at least 20 consecutive carbon atom chain. The polyester polymer may be a reaction product of a polyol with a polyester (e.g., a diester) including an at least 10 consecutive carbon atom chain, such as at least 12, such as an at least 14, at least 16, at least 18, or at least 20 consecutive carbon atom chain. The polyester polymer may be a reaction product of a polyol including an at least 12 consecutive carbon atom chain, such as at least 14, at least 16, at least 18, or at least 20 consecutive carbon atom chain and a polyester or polyacid. Thus, the polyester polymer may include a polyester polyol polymer and/or a polyester polyacid polymer.

Suitable polyacids for preparation of the polyester polymer include, but are not limited to, saturated polyacids such as adipic acid, azelaic acid, sebacic acid, succinic acid, glutaric acid, octadecanedioic acid, hexadecanedioic acid, tetradecanedioic acid, decanoic diacid, dodecanoic diacid, cyclohexanedioic acid, hydrogenated C36 dimer fatty acids, and esters and anhydrides thereof. Suitable polyacids include polyacid halides. The polyacid may comprise from 20 to 80 weight percent of the reaction mixture, such as from 30 to 70 weight percent or from 40 to 60 weight percent. Combinations of any of these polyacids may be used.

Suitable polyesters for preparation of the polyester polymer include, but are not limited to, esters of the above-listed suitable polyacids. The polyester may comprise from 20 to 80 weight percent of the reaction mixture, such as from 30 to 70 weight percent or from 40 to 60 weight percent. Combinations of any of these polyesters may be used.

Suitable polyols for preparation of the polyester polymer include, but are not limited to, any polyols known for making polyesters. Examples include, but are not limited to, alkylene glycols, such as ethylene glycol, propylene glycol, diethylene glycol, dipropylene glycol, 1,2-propylene glycol, triethylene glycol, tripropylene glycol, hexylene glycol, polyethylene glycol, polypropylene glycol and neopentyl glycol; hydrogenatedbisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; 2,2,4-trimethyl-1,3-pentanediol, cyclohexanedimethanol; hexanediols including 1,6-hexanediol; 2-ethyl-1,3-hexanediol, caprolactonediol (for example, the reaction product of epsilon-caprolactone and ethylene glycol); hydroxyalkylated bisphenols; polyether glycols, for example, poly(oxytetramethylene) glycol; trimethylol propane, di-trimethylol propane, pentaerythritol, di-pentaerythritol, trimethylol ethane, trimethylol butane, dimethylol cyclohexane, glycerol, tris(2-hydroxyethyl) isocyanurate and the like.

Combinations of any of these polyols may be used to form at least one polyester polymer used in the conductive polymer composition. The conductive polymer composition may include a plurality of different types of polyester polymers, each polyester polymer prepared using a different polyol and/or combination of polyols. The conductive polymer composition may include a single type of polyester polymer, with the polyester polymer prepared including a plurality of different types of polyols. The combination of polyols (used to prepare the single or multiple polyester polymers for inclusion in the conductive polymer composition) may include, as non-limiting examples, at least one of 1,2 butane diol, 1,3 butane diol, 1,4 butane diol, and 1,6 hexane diol.

The polyester polymer may have a hydroxyl value on solids of 5-120 mg KOH/g, such as 10-100 mg KOH/g as measured by ASTM D4274-16. The polyester polymer may have an acid value on solids of 5-120 mg KOH/g, such as 10-100 mg KOH/g as measured according to ASTM D4662-15. The polyester polymer may have an average molecular weight (Mn) of 1,000-15,000 g/mol, such as 1,500-10,000 g/mol, such as 2,000-8,000 g/mol. The polyester polymer may have weight average molecular weight (Mw) of 1,000-90,000 g/mol, such as 1,500-60,000 g/mol, such as 2,000-48,000 g/mol, such as 3,000-30,000 g/mol. The Mn and Mw can be measured by gel permeation chromatography relative to linear polystyrene standards of 580 to 2,698,000 g/mol such as by using a WATERS 2695 separation module with a WATERS 2414 differential refractometer (RI detector) with a tetrahydrofuran (THF) eluent at a flow rate of 1 ml/min, and two PLgel MixedC (300×7.5 mm) columns for separation at room temperature.

The polyester polymer itself (of the conductive polymer composition) may be a non-conductive polymer.

The polyester polymer, PTC resin, may include at least 5 weight percent of the total weight of the coating composition, such as at least 10 weight percent, at least 20 weight percent, or at least 30 weight percent. The polyester polymer may include up to 40 weight percent, up to 50 weight percent, up to 60 weight percent, up to 70 weight percent, or up to 80 weight percent, such as 90 weight percent of the total weight of the coating composition. The polyester polymer may include from 5 to 40 weight percent of the coating composition, such as from 10 to 30 weight percent, or from 10 to 20 weight percent.

The polyester polymer, PTC resin, may include at least 5 weight percent of the weight of the coating composition based on total solids (non-volatile portion), such as at least 10 weight percent, at least 20 weight percent, or at least 30 weight percent. The polyester polymer may include up to 90 weight percent of the weight of the coating composition based on total solids, such as up to 85 weight percent, up to 80 weight percent, or up to 75 weight percent. The polyester polymer may include from 5 to 90 weight percent of the weight of the coating composition based on total solids, such as from 10 to 85 weight percent or from 20 to 85 weight percent.

The polyester polymer may be included in the coating composition with other polymers. The polyester polymer may be incorporated as a segment of a polymer included in the coating composition. For example, the polyester polymer may be reacted with an isocyanate to form a polyurethane polymer comprising the polyester polymer as a segment thereof (still a polyester polymer as well). The polyester segment of the polyurethane polymer would still result in PTC performance of the polymer, as the polyester segment would still expand at specific temperatures.

The coating composition can further comprise a crosslink inhibitor. The crosslink inhibitor can inhibit, if not prevent, crosslinking of the film-forming resin. The crosslink inhibitor can be used to control the conditions under which the film-forming resin can cure. The crosslink inhibitor can be at least partially deactivated, which may include the crosslink inhibitor being removed, degraded, reacted, or a combination thereof, responsive to the external stimulus such that the ability of the crosslink inhibitor to inhibit, if not prevent, crosslinking of the film-forming resin is reduced. After the reduction of inhibition, the resulting coating composition can cure. For example, the crosslink inhibitor can inhibit curing of a PTC resin in a contracted state and facilitate curing of the PTC resin in an expanded state such that the electrical resistivity of the coating is irreversibly increased.

The crosslink inhibitor can comprise a solvent, an acid, a base, a metal chelator, or a combination thereof. For example, the crosslink inhibitor can comprise dimethylethanolamine, propionic acid, acetic acid, an amine, ammonia, acetylacetone, a thiol, or a combination thereof.

The coating composition can comprise an additional component, such as, for example, a pigment, a plasticizer, an abrasion-resistant particle, a film-strengthening particle, a flow control agent, a thixotropic agent, a rheology modifier, cellulose acetate butyrate, a catalyst, an antioxidant, a biocide, a defoamer, a surfactant, a wetting agent, a dispersing aid, an adhesion promoter, a clay, a hindered amine light stabilizer, an ultraviolet light absorber and/or stabilizer, a stabilizing agent, a filler, an organic solvent, water, a reactive diluent, a grind vehicle, or combinations thereof.

The coating composition can form a coating and/or film suitable to assist in electrodeposition and/or electrostatic assisted application of a subsequent coating layer. The coating composition can be formulated as a solvent-based composition, a water-based composition, or a 100% solid (i.e., non-volatile) composition that does not comprise a volatile solvent (e.g., readily vaporizable at ambient temperatures) or aqueous carrier. For example, the coating composition can be formulated as a liquid, paste, slurry, or powder depending on the desired application. The coating composition can be a liquid at a temperature of −10° C. or greater, such as, for example, 0° C. or greater, 10° C. or greater, 30° C. or greater, 40° C. or greater, or 50° C. or greater. The coating composition can be a liquid at a temperature of 60° C. or lower, such as, for example, 50° C. or lower, 40° C. or lower, 30° C. or lower, 10° C. or lower, or 0° C. or lower. The coating composition can be a liquid at a temperature in a range of −10° C. to 60° C., such as, for example, −10° C. to 50° C., −10° C. to 40° C., −10° C. to 30° C., or 0° C. to 40° C. The coating composition can be a liquid at ambient temperature.

As used herein, “ambient temperature” refers to a temperature of 23° C.+/−3° C.

The present disclosure provides a method of making a radar transmissive system including a coating formed from the coating composition. The method can comprise applying the coating composition according to the present disclosure over a first surface of a substrate. The coating composition can be applied using at least one of electrodeposition, electrostatic assisted application, spray coating, spin coating, dip coating, roll coating, flow coating, slot die coating, brush coating, in-mold coating, film coating, extruding, dispensing (e.g., ribbon dispensing), or a combination thereof. The coating composition may be manufactured as a preformed film and thereafter applied over at least a portion of the substrate.

As used herein, the terms “on,” “applied over,” “applied on,” “formed over,” “formed on, “deposited over,” “deposited on,” “overlay,” “provided over,” “provided on,” and the like, mean formed, overlaid, deposited, or provided on but not necessarily in contact with the surface. For example, a formed layer “applied over” a substrate layer does not preclude the presence of one or more other layers of the same or different composition located between the formed layer and the substrate layer.

The substrate can be at least partially coated with the coating composition. For example, the coating composition according to the present disclosure can be applied over 1% or greater of the first surface of the substrate layer, such as, for example, 10% or greater, 20% or greater, 50% or greater, 70% or greater, 90% or greater, or 99% or greater of the first surface of the substrate. The coating composition according to the present disclosure can be applied over 100% or lower of the first surface of the substrate layer, such as, for example, 99% or lower, 90% or lower, 70% or lower, 50% or lower, 20% or lower, or 10% or lower of the first surface of the substrate. The coating composition according to the present disclosure can be applied over 1% to 100% of the first surface of the substrate, such as, for example, 5% to 99%, 5% to 90%, 5% to 70%, 5% to 20%, or 50% to 100% of the first surface of the substrate.

After applying the coating composition over the substrate, the coating composition may be allowed to coalesce to form a substantially continuous film on the substrate, and the coating composition can be cured and/or dried to form a first self-supporting coating.

The first self-supporting coating can be a coating, a film, or a combination thereof. As used herein, a “coating” is a surface covering, such as, for example, a paint for at least a portion of an object that can be applied in, for instance, liquid, paste, slurry, or powder form, which upon drying and/or curing, forms a self-supporting continuous film over a least a portion of the object. A film is a surface covering for at least a portion of an object that is applied as a solid and pliable layer, which is cured and/or dried prior to application to at least a portion of the object. The first self-supporting coating can be a pretreatment layer, an adhesion promoter layer, a basecoat layer, a mid-coat layer, a topcoat layer, a primer layer, or a combination thereof.

[1] A second coating composition can be applied over the first self-supporting coating. The second coating composition can be deposited using at least one of electrodeposition and electrostatic assisted application such that the first self-supporting coating is electrically charged (e.g., negatively charged) and the second coating composition is electrically charged (e.g., positively charged) during at least a portion of the application of the second coating composition. The application of the second coating composition can occur prior to subjecting the first self-supporting coating to an external stimulus. After applying the second coating composition over the first self-supporting coating, the second coating composition may be allowed to coalesce to form a substantially continuous film on the cured coating, and the second coating composition can be cured to form a second cured coating.

The first self-supporting coating can be exposed to an external stimulus such that the resistivity of the first self-supporting coating composition can irreversibly increase. The first self-supporting coating can irreversibly increase in resistivity by at least 20%, at least 50%, at least 100%, at least 500%, at least 1,000%, at least 10,000%, at least 100,000%, or at least 300,000%, all as measured with a probe prior to and after exposing the coating to an external stimulus. For example, the first self-supporting coating can irreversibly increase in resistivity by at least 0.5 ohm×cm, such as, at least 0.75 ohm×cm, at least 1 ohm×cm, at least 2 ohm×cm, at least 10 ohm×cm, at least 50 ohm×cm, at least 100 ohm×cm, at least 500 ohm×cm, at least kohm×cm, at least 100 kohm×cm, at least 500 kohm×cm, or at least 1 mohm×cm, all as measured with a four-point probe after exposing the coating to an external stimulus. For example, the first electrical resistivity of the first self-supporting coating can increase to a second electrical resistivity. The second electrical resistivity can be non-conductive. As used herein, “non-conductive” means the element comprises an electrical resistivity of at least 1 ohm×cm as measured with a four-point probe, such as, for example, at least 1.5 ohm×cm, at least 2 ohm×cm, or at least 5 ohm×cm, at least 10 ohm×cm, at least 50 ohm×cm, at least 100 ohm×cm, at least 500 ohm×cm, at least 1 kohm×cm, at least 100 kohm×cm, at least 500 kohm×cm, or at least 1 mohm×cm, all as measured with a four-point probe.

As used herein “irreversible” and “irreversibly” when referring to the electrical resistivity of the coating means that the electrical resistivity does not revert to the previous electrical resistivity after the external stimulus is removed. For example, a self-supporting coating has a first electrical resistivity prior to the external stimulus and the electrical resistivity of the self-supporting coating increases after subjecting the first self-supporting coating to the external stimulus. After the external stimulus is removed, the electrical resistivity of the self-supporting coating may change over time but the electrical resistivity of the self-supporting coating will not revert to the first electrical resistivity and the electrical resistivity of the self-supporting coating may remain at least 0.5 ohm×cm greater than the first electrical resistivity, such as, for example, at least 0.75 ohm×cm, at least 1 ohm×cm, at least 2 ohm×cm, at least 10 ohm×cm, at least 50 ohm×cm, at least 100 ohm×cm, at least 500 ohm×cm, at least 1 kohm×cm, at least 100 kohm×cm, at least 500 kohm×cm, or at least 1 mohm×cm greater than the first electrical resistivity.

The external stimulus can comprise heat, actinic radiation (e.g., particle radiation, and/or electromagnetic radiation), electrical current, application of a chemical agent, other stimulus to interrupt the percolation or conductive path, or a combination thereof. The external stimulus can be applied for a time and/or in an amount suitable to irreversibly increase the electrical resistivity of a coating and/or coating composition and substantially maintain desirable aesthetics (e.g., appearance, color) and mechanical properties. In general, the aesthetics may also include surface roughness (which also contributes to mechanical properties), whereas the mechanical properties will typically include at least cohesion, and adhesion with an adjacent layer after application of the external stimulus. The external stimulus can at least partially remove, degrade, change a pHase of, change a shape of, and/or change a morphology of, the film-forming resin, the conductive additive, the crosslinking agent, and/or the crosslink inhibitor.

As mentioned above, the external stimulus can be applied for a time and/or in an amount suitable to irreversibly increase the electrical resistivity of a coating and/or coating composition, and substantially maintain desirable aesthetic properties (e.g., appearance, color) and mechanical properties. The time can be from 0.0001 seconds to 12 hours, such as 0.001 seconds to 8 hours, and can vary based on the external stimulus used. For example, when the stimulus is actinic radiation, or electrical current, the stimulus can be applied from 0.0001 seconds to 4 hours, such as 0.0001 seconds to 2 hours, such as 0.0001 seconds to 1 hour, such as 0.0001 seconds to 30 minutes, such as 0.0001 seconds to 10 minutes, such as 0.001 seconds to 5 minutes. Further, when the external stimulus is heat, the time can be from 0.1 seconds to 12 hours, such as 1 second to 8 hours, such as 1 second to 4 hours, such as 1 second to 1 hours, such as 1 minute to 1 hour, and can vary based on the temperature selected as the external stimulus.

As may be understood, more than one temperature of the heat external stimulus may be effective, but that a lower temperature may require longer time than a higher temperature to achieve a suitable irreversible increase the electrical resistivity of a coating and/or coating composition. When the desired external stimulus is application of a chemical agent, the chemical agent may stay in contact with the coating and/or coating composition or the chemical agent may have a mode of removal, such as volatilization. In instances where there is a mode of removal, the contact time of the chemical agent as the external stimulus can be at least 1 second, such as 10 seconds, such as 1 minute, such as 5 minutes, such as 10 minutes, such as 20 minutes, such as 30 minutes and up to at most 1 year, such as 6 months, such as 3 months, such as 1 month, such as 1 week, such as 1 day, such as 8 hours, such as 4 hours, such as 1 hour or within any range using any two of the foregoing values as endpointₛ, such as 1 second to 1 year, such as 10 seconds to 6 months, such as 1 minute to 8 hours, such as 1 minute to 1 hour. 490 [2] Subjecting the first self-supporting coating to the external stimulus can comprise heating the first self-supporting coating in an oven, with a heat gun, with a heat lamp, or other apparatus. The external stimulus can comprise heating the first self-supporting coating to a temperature of at least 30° C., such as, at least 40° C., at least 50° C., at least 60° C., at least 70° C., or at least 80° C. The external stimulus can comprise heating the first self-supporting coating to a temperature of in a range of 30° C. to 200° C., such as, 40° C. to 200° C., 50° C. to 200° C., 60° C. to 200° C., 60° C. to 150° C., or 60° C. to 120° C. For example, in examples including a coating composition comprising a PTC resin, a crosslinker, and a crosslink inhibitor, the coating composition can be applied to a surface and then dried to form a self-supporting coating. Then, the heating can at least partially remove and/or degrade the crosslink inhibitor in the self-supporting coating at a desired temperature such that the PTC resin can be substantially fixed in the expanded state by curing of the self-supporting coating.

Subjecting the first self-supporting coating to the external stimulus can comprise irradiating the first self-supporting coating with a particle radiation source. The particle radiation can comprise ionizing radiation, such as alpha radiation, beta radiation, gamma radiation or a combination thereof. For example, the particle radiation can degrade the crosslink inhibitor and/or the conductive additive.

Subjecting the first self-supporting coating to the external stimulus can comprise irradiating the first self-supporting coating with an electromagnetic source, such as, for example, a lamp, an LED, a laser diode, another electromagnetic source, or a combination thereof. For example, electromagnetic radiation can comprise ultraviolet radiation (e.g., 100 nm to 400 nm), visible radiation (e.g., 400 nm to 700 nm), infrared radiation (e.g., 700 nm to 1 mm), or a combination thereof. For example, the electromagnetic radiation can degrade the crosslink inhibitor and/or the conductive additive.

515 Subjecting the first self-supporting coating to the external stimulus can comprise applying an electrical current to the first self-supporting coating with a power supply, such as, for example, a DC current supply and/or an AC current supply. The electrical power used in the external stimulus can be greater than electrical power used during application of the second coating composition. For example, the electrical current can degrade the crosslink inhibitor and/or the conductive additive.

Subjecting the first self-supporting coating to the external stimulus can comprise applying a chemical agent to the first self-supporting coating such that a chemical property of the first self-supporting coating can be changed. For example, the chemical agent can comprise water, an acid, a base, other chemical, or a combination thereof. The application of the chemical agent can increase the moisture content of the first self-supporting coating; decrease a pH of the first self-supporting coating; increase a pH of the first self-supporting coating; change the shape of a chemical structure in the first self-supporting coating; block electrical pathways in the first self-supporting coating; and/or otherwise affect a chemical structure and/or bond in the first self-supporting coating, which can cause an irreversible increase in resistivity of the first self-supporting coating. The application of the chemical agent can be separate or the chemical agent can be present in the second coating composition and be applied concurrently with the second coating composition.

The first self-supporting coating can substantially maintain desirable aesthetics, surface roughness, cohesion, and adhesion with an adjacent layer after application of the external stimulus. The aesthetics of a coating, film, and/or article can be quantified using the international commission on illumination (CIE) L15 value as discussed here. CIE lab (or CIE Lch), color values can be measured using a multi-angle spectrophotometer, such as a BYKMAC I, from ALTANA, at the measurement angles of 15°, 25°, 45°, 75°, and/or 110° relative to the specular direction, with D65 illumination and 10° observer. For example, the first self-supporting coating can comprise a CIELAB AE of 15 or less compared to the first self-supporting coating before the external stimulus is applied, such as, 10 or less, 5 or less, or or less, all as measured at 15°, using a multi-angle spectrophotometer with D65 illumination and 10° observer. The AE is the difference between two colors in the CIELAB color space based on the difference between collected values of L, a, and b, according to equation 1.

$$Δ E = \sqrt{{( Δ {L}^{*} )}^{2} + {( Δ {a}^{*} )}^{2} + {( Δ {b}^{*} )}^{2}} \qquad Equation 1$$

The first self-supporting coating can maintain adhesion with the substrate, adhesion with a top coat, a surface roughness, appearance, and/or color after subjecting the first self-supporting coating to the external stimulus. The first self-supporting coating may not form bubbles or cracks after the external stimulus.

The first self-supporting coating can comprise a surface roughness change of 20 units or less of distinctness of image (DOI) compared to the first self-supporting coating before the external stimulus is applied as measured with a BYK WAVESCAN. The first self-supporting coating can comprise a adhesion rating drop of 2 units or less compared to the first self-supporting coating before the external stimulus is applied as measured according to ASTMD3359-22 test method B on 0B-5B scale.

The coating composition according to the present disclosure can be selected based on the external stimulus to be used or the external stimulus can be selected based on the coating composition according to the present disclosure. The conductive additive can comprise carbon nanotubes and/or a conductive polymer configured to degrade in response to an external stimulus. The carbon nanotubes can be subjected to heating and/or electromagnetic radiation where the crystalline structure of the carbon nanotubes changes after the external stimulus. The carbon nanotubes can be decorated with various chemical groups to change their response to the external stimulus and/or their conductivity. The conductive polymer can be subjected to ultraviolet radiation which can break conductive chemical pathways within the polymer.

The figure is a schematic view of a radar transmissive system 100 of the present disclosure comprising a substrate 102, a first layer 104, and a second layer 106. The substrate 102 comprises a first surface 102a and a second surface 102b positioned opposite the first surface 102a. The first surface 102a and the second surface 102b can be parallel or may not be parallel. In use, the second surface 102b can be directed towards a radar system 108.

To form the first layer 104, the coating composition according to the present disclosure can be applied over at least a portion of the first surface 102a of the substrate 102 and cured and/or dried. To form the second layer 106, a second coating composition can be applied over at least a portion of a first surface 104a of the first layer 104. The second layer 106 can be a different layer than the first layer 104. For example, the second layer 106 can be a basecoat layer, a mid-coat layer, or a topcoat layer.

The first layer 104 and the second layer 106, individually, can be an automotive original equipment manufacturer coating, an automotive refinish coating, an industrial coating, an architectural coating, a coil coating, a packaging coating, a marine coating, an aerospace coating, a consumer electronic coating, the like, or combinations thereof.

The second layer 106 can comprise a film-forming resin and optionally a pigment. As used herein, “pigment” refers to an insoluble particle that provides reflective characteristics in the visible wavelengths of the electromagnetic spectrum. As used herein, the term “visible” refers to the visible wavelengths of the electromagnetic spectrum. For example, the visible wavelengths may be in a range of 400 nm to 700 nm. The pigments can provide visible light reflective characteristics to a composition that incorporates the pigment.

As used herein, “insoluble” in reference to a pigment means the pigment (including the components that comprise the pigment) is insoluble in water and the typical solventₛ, such as organic solventₛ, used in coating compositions, film compositions, and article of manufacture compositions. Solubility may be tested, for example, by making a 1 weight percent (wt %) mixture of the solute (e.g., pigment particle) in the desired medium based on the total weight of mixture, such as water and/or organic solvent(s), at ambient temperature. If the pigment dissolves into the desired medium, it is soluble. If the pigment remains as a separate phase, it is insoluble. Thus, when formulating a coating, a film, or an article incorporating the pigment, solvent(s) in which the pigment is insoluble may be chosen.

The substrate 102 can comprise a radar transmissive substrate. A “radar transmissive substrate” means a substrate having a composition and a thickness suitable to transmit electromagnetic radiation at various radar frequencies (e.g., in the range of automotive frequencies of 76 GHz to 81 GHz) with minimal, if any, transmission loss. “Minimal” with respect to transmission loss is meant to mean no greater than 5 db, such as, for example, no greater than 4 db, no greater than 3 db, no greater than 2 db, no greater than 1 db, no greater than 0.5 db, no greater than 0.2 db, or no greater than 0.1 db. For example, a radar transmissive substrate can be transparent to the various radar frequencies. That is, a radar transmissive substrate can have a one way radar transmission loss (OWRTL), as set forth below, of no greater than 5 db as measured by using a radar transmission system in the radar range of 76 GHz to 81 GHz as described below. Radar transmissive substrates may be nonmetallic and include polymeric substrates (e.g., a polymer), such as plastic, including polyester, polyolefin, polyamide, cellulosic, polystyrene, polyethylene terephthalate, polyacrylic, poly(ethylene naphthalate), polypropylene, polyethylene, polyepoxide, nylon, ethylene vinyl alcohol copolymer, polylactic acid, other “green” polymeric substrates, polycarbonate, polycarbonate acrylobutadiene styrene, polyurethane, thermoplastic olefins, or combinations thereof. The radar transmissive substrate may be filled or unfilled plastic. A filled plastic comprises a plastic with additives such as fibers, such as glass fibers, and/or particles, such as talc. For example, the radar transmissive substrate can comprise carbon fiber. A filled plastic may also be referred to as a composite. The radar transmissive substrate can comprise glass, wood, or a combination thereof.

The substrate 102 can be an automotive substrate, an industrial substrate, an architectural substrate, a coil substrate, a packaging substrate, a marine substrate, an aerospace substrate, a consumer electronic device substrate (e.g., a phone, computer, or tablet), or combinations thereof. The substrate 102 can be a bumper fascia, a mirror housing, a fender, a hood, a trunk, a door, a radar enclosure, an antenna enclosure, the like, or a combination thereof, or an aerospace part, such as, for example, a nose cone, a radome, the like, or a combination thereof. “Automotive” as used herein refers to in its broadest sense all types of vehicles, such as, but not limited to, cars, trucks, buses, tractors, harvesters, heavy duty equipment, vans, golf cartₛ, motorcycles, bicycles, railcars, airplanes, helicopters, boats of all sizes, and the like.

The dry film thickness, t₁, of the first layer 104, and the dry film thickness, t₂, of the second layer 106, individually, can be at least 0.2 μm, such as, for example, at least 0.25 μm, at least 1 μm, at least 5 μm, at least 10 μm, at least 20 μm, at least 30 μm, at least 50 μm, or at least 100 μm. The dry film thickness, t₁, of the first layer 104, and the dry film thickness, t₂, of the second layer 106, individually, can be no greater than 1000 μm, such as, for example, no greater than 900 μm, no greater than 800 μm, no greater than 750 μm, no greater than 500 μm, no greater than 200 μm, no greater than 100 μm, no greater than 80 μm. The dry film thickness, t₁, of the first layer 104, and the dry film thickness, t₂, of the second layer 106, individually, can be in a range of 0.2 μm to 1000 μm, such as, for example, 10 μm to 500 μm, 1 μm to 100 μm, 0.25 μm to 130 μm, 2 μm to 50 μm, or 10 μm to 25 μm.

The thickness, tₛ, of the substrate 102 can be at least 0.2 mm, such as, for example, at least 0.5 mm, at least 2 mm, or at least 2.5 mm. The thickness, tₛ, of the substrate 102 can be no greater than 6 mm, such as, for example, no greater than 5 mm, no greater than 4 mm, or no greater than 3.5 mm. The thickness, tₛ, of the substrate 102 can be in a range of 0.2 mm to 6 mm, such as, for example, 0.5 mm to 6 mm, 2 mm to 5 mm, 2.5 mm to 4 mm, or 2.5 mm to 3.5 mm.

OWRTL, as set forth below, can quantify the radar transmission loss, if any, of radar transmitted through the radar transmission system 100. OWRTL can be measured in db using radome measurement system-desktop (RMS-D) (October 2021 specifications) from PERISENS GMBH. The RMS-D from PERISENS can comprise a frequency range of 76 GHz to 81 GHz and a measurement accuracy of +/−0.1 db.

The radar transmission loss in db can be calculated with equation 2.

$$OWRTL ( db ) = free space transmission ( dbm ) - sample transmission ( dbm ) . \qquad Equation 2$$

The radar transmission loss is related to the % transmittance (% T) of a radar signal by equation 3.

$$\% T = 100 \times 1 {0}^{- ( OWRTL / 10 )} . \qquad Equation 3$$

The first layer 104 and/or the radar transmissive system 100 can transmit 10% or more of electromagnetic radiation comprising a frequency of 1 GHz to 300 GHz, such as, 1 GHz to GHz or 76 GHz to 81 GHz, through the coating after the external stimulus compared to the transmission of electromagnetic radiation through the coating prior to the external stimulus, such as, 20% or more, 30% or more, 40% or more, 50% or more, 75% or more, 100% or more, 200% or more, or 300% or more. The 76 GHz to 81 GHz wavelength range (e.g., 77 GHz) can be utilized for automotive radar and other radar applications. For example, the first layer 104 and/or radar transmissive system can transmit 10% or more of electromagnetic radiation at a specific frequency and/or for all frequencies in a range of 1 GHz to 300 GHz, as desired, such as, for example, at a frequency of 76 GHZ, 76.5 GHZ, 77 GHZ, and/or 81 GHZ.

The present disclosure provides an assembly comprising the radar transmissive system and the radar system 108. The radar system 108 can be configured for various uses, including blind spot detection, lane change assistance, collision mitigation, collision warning, parking aid, rear cross track alert, adaptive cruise, pre-crash, back up parking aid, rear crash avoidance, other function, or a combination thereof. The radar system 108 can detect a distance between the radar system 108 and another object 110. The radar system 108 can be, for example, a direct propagation radar system, an indirect propagation radar system, phased array radar, 4D radar, or a combination thereof.

The radar system 108 can be configured to transmit electromagnetic radiation 112 through the radar transmissive system 100 and receive electromagnetic radiation 114 reflected by an object 110. The radar system 108 may be positioned proximal to and/or adjacent to the substrate 102. The radar system can transmit electromagnetic radiation 112 that can traverse through the radar transmissive system 100. The radar transmissive system 100 can minimally, if at all, reduce the transmission of the electromagnetic radiation 112 therethrough such that the electromagnetic radiation 112 can exit the radar transmissive system 100. The electromagnetic radiation 112 that exits the radar transmissive system 100 can be used for the detection of an object 110. For example, the electromagnetic radiation 112 can reflect off of the object 110 and return as electromagnetic radiation 114 through the radar transmissive system 100 to the radar system 108.

In addition to the first layer 104 and second layer 106, the radar transmissive system can optionally further comprise a pretreatment layer, an adhesion promoter layer, a basecoat layer, a mid-coat layer, a topcoat layer, a primer layer, or a combination thereof applied over at least a portion of the first surface 102a of the substrate 102. For example, there may be a single-layer or a multilayer coating stack applied over at least a portion of the first surface 102a, such as a multilayer coating stack including at least three layers, the first layer 104, the second layer 106, and a tertiary layer underneath or on top of at least a portion of the first layer 104 or the second layer 106. Additional layers, such as, for example, a pretreatment layer, an adhesion promoter layer, a basecoat layer, a mid-coat layer, a topcoat layer (e.g., clear coat, tinted clear coat), a primer layer, or combinations thereof, may be deposited before or after the first layer 104 and the second layer 106. The tinted clear coat can be, for example, a clear coat to which dyes and or pigments are added, including the nano-sized pigment dispersions, all of which are hereby incorporated by reference herein. The tinted clear coat can comprise nano-sized pigment dispersions with an average primary particle size of less than 150 nm as measured with a transmission electron microscopy (TEM), such as, for example, less than 100 nm as measured with a TEM. The nano-sized pigment dispersions can have an average primary particle size in a range of 20 nm to 150 nm, such as, for example, 20 nm to nm, 20 nm to 80 nm, 20 nm to 60 nm, or 20 nm to 40 nm. For example, the nano-sized pigments dispersions can have a particle size of 25 nm, 35 nm, or 50 nm. As used herein, average particle size is measured with a TEM refers to the average feret diameter of the particle as measured by TEM.

A coating stack for use in automotive applications may comprise an adhesion promoter layer applied over at least a portion the substrate 102, a primer layer disposed over the adhesion promoter layer, a basecoat layer disposed over the primer layer, and a clear coat disposed over the basecoat layer. The first layer 104 can be the adhesion promoter layer, the primer layer, the basecoat layer, or the clearcoat layer. The second layer 106 can be the primer layer, the basecoat layer, or the clearcoat layer and different from the first layer 104.

A coating stack as applied over at least a portion of the substrate 102, such as, for example, in automotive refinish or aerospace applications, may comprise an optional pretreatment layer and/or adhesion promoter layer, a primer layer, a basecoat layer, and a clear coat. A coating stack as applied over at least a portion of the substrate 102, such as, for example, in automotive refinish, general industrial, or aerospace applications, can comprise an optional pretreatment or adhesion promoter layer, a primer layer, and a direct gloss topcoat layer. A direct gloss topcoat layer means a layer comprising both the color and gloss in one coating that is typically the last applied coating of a coating stack. An additional clear coat can optionally be applied over at least a portion of a direct gloss topcoat layer.

The film can be a multilayer film comprising at least two layers, including a first film layer comprising a thermoset or thermoplastic layer and an optional adhesive layer. The adhesive layer can be protected with a removable layer or release liner that would be removed prior to application of the film to a substrate. The first film layer may be applied over at least a portion of a carrier film that would support the first film layer until the first film layer is formed, and thereafter the carrier film may optionally be removed. The first film layer may be applied over at least a portion of a protective clear film that itself may be on a carrier film. The protective clear film may be thermoset or thermoplastic and would be the top layer when the multilayer film is applied over at least a portion of the substrate 102 via contact of the adhesive layer with the substrate 102. A layer of the multilayer film may comprise thermoset or thermoplastic polyurethane. The first film layer of the film may be spray applied, extruded, formed, or polymerized in situ, or otherwise deposited to an adjacent layer of a multilayer film or to a removable layer.

In-mold coating (IMC) is an alternative to painting for injection molded plastic parts. IMC can be done by applying a coating composition by spraying, injecting or other known means in the art, onto the surface of the article of manufacture while it is still in the mold. The coating then solidifies and adheres to the article. A coating composition or film can be applied in mold prior to injection molding of an article of manufacture such that the coating or film is applied over at least a portion of the surface of the molded article or manufacture. Both methods are IMC according to the present disclosure.

The present disclosure also provides a method for improving radio detection and ranging in an electromagnetic radiation frequency range of 1 GHz to 300 GHz, such as, 1 GHz to 100 GHz or 76 GHz to 81 GHz, with radar systems that are mounted behind coated articles. The method comprises applying a coating and/or film formed from the coating composition according to the present disclosure to a substrate and subjecting the coating and/or film to the external stimulus. The improvement can be relative to the coated article prior to the external stimulus.

As used herein, unless otherwise expressly specified, all numbers, such as those expressing values, ranges, amounts, or percentages, may be read as if prefaced by the word “about,” even if the term does not expressly appear. Any numerical range recited herein is intended to include all sub-ranges subsumed therein. The plural encompasses the singular and vice versa. For example, while the present disclosure has been described in terms of “a” layer, “a” substrate, “a” radar transmissive substrate, “a” pigment, and the like, more than one of these and other components, including mixtures, can be used. When ranges are given, any endpoints of those ranges and/or numbers within those ranges can be combined with the scope of the present disclosure. “Including,” “such as,” “for example,” and like terms mean “including/such as/for example but not limited to.”

Also, as used herein, the term “polymer” is meant to refer to prepolymers, oligomers, and both homopolymers and copolymers; and the prefix “poly” refers to two or more. The terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, ethacrylic acid, etc., And their C₁-C₆ alkyl esters and hydroxyalkyl esters, unless clearly indicated otherwise.

As used in this specification, the term “formed” refers to the creation of an object from a composition by a suitable process, such as, curing. For example, a coating formed from a curable coating composition refers to the creation of a single or multiple layered coating or coated article from the curable coating composition by curing the coating composition under suitable process conditions.

### EXAMPLES

The present disclosure will be more fully understood by reference to the following examples, which provide illustrative non-limiting aspects of the disclosure. It is understood that the disclosure described in this specification is not necessarily limited to the examples described in this section.

As used herein, the term “parts” refers to parts by weight unless indicated to the contrary.

Electrical resistance was measured with a probe of a 1587 FC insulation multi-meter from FLUKE, the probe being applied in ohm meter mode.

### Positive Temperature Coefficient (PTC) Resin Examples

### PTC Resin 1 (PTC 1)

A positive temperature coefficient (PTC) resin was prepared by adding 345.45 grams of octadecanedioic acid, 152.18 grams of 1,2-propylene glycol, and 2.54 grams of butyl stannoic acid to a suitable reaction vessel equipped with a stirrer, temperature probe, and Dean-Stark trap with a condenser, under a nitrogen atmosphere. The contents of the reactor were gradually heated to 130° C., and held until the exotherm had subsided or about 1 hour if no exotherm was observed. Then the temperature was raised to 180° C. and after about 20 minutes a light sparging with nitrogen was started and water distillate was collected. After about 2 hours the temperature was raised to 200C and held until water distillate was no longer observed and the acid value was lower than 1 mg KOH/g. The temperature was lowered to 175° C. and 48.03 grams of trimellitic anhydride was added and held at temperature until the acid value was about 28 mg KOH/g. Then the temperature was set to 60° C. and a mixture of 863.22 grams AROMATIC 200 (available from EXXONMOBIL CORP.) and 575.48 grams of diacetone alcohol were added to further cool and dilute the resin.

The final resin solution had a measured percent solids (110° C./1 hour), as described in ASTM D2369, of 23.9 wt %, and a theory hydroxyl value of 26.9 mg KOH/g. Gel permeation chromatography was used with tetrahydrofuran solvent and polystyrene standards to determine a weight average molecular weight (Mw) of 10,060 g/mol and number average molecular weight (Mn) of 2,886 g/mol. Mw and/or Mn, as reported herein, was measured, unless otherwise indicated, by gel permeation chromatography using a polystyrene standard according to ASTM D6579-11 (performed using a Waters 2695 separation module with a Waters 2414 differential refractometer (RI detector); tetrahydrofuran (THF) was used as the eluent at a flow rate of 1 ml/min, and two PLgel MixedC (300×7.5 mm) columns were used for separation at the room temperature; weight and number average molecular weight of polymeric samples can be measured by gel permeation chromatography relative to linear polystyrene standards of 800 to 900,000 Da).

### 815 PTC Resin 2 (PTC 2)

A positive temperature coefficient (PTC) resin, used in some of the following examples, was prepared by adding 150.95 grams of octadecanedioic acid, 48.70 grams of 1,2-propylene glycol, and 0.81 grams of butyl stannoic acid to a suitable reaction vessel equipped with a stirrer, temperature probe, and dean-stark trap with a condenser, under a nitrogen atmosphere. The contents of the reactor were gradually heated to 130° C. and held until the exotherm had subsided or 1 hour if no exotherm was observed. Then the temperature was raised to 180° C. and after 20 minutes a light sparging with nitrogen was started and water distillate was collected. After 2 hours the temperature was raised to 200° C. and held until water distillate was no longer observed and the acid value was lower than 2 mg KOH/g. The temperature was lowered to 175° C. and 15.37 grams of trimellitic anhydride was added and held at temperature until the acid value was 35 mg KOH/g. Then the temperature was set to 60° C. and a mixture of 276.23 grams aromatic 200 (available from EXXONMOBIL CORP.) And 184.15 grams of diacetone alcohol were added to further cool and dilute the resin.

The final resin solution had a measured percent solids (110° C./1 hour), as described in ASTM D2369, of 20.9 wt %, and a theory hydroxyl value of 21.7 mg KOH/g. Gel permeation chromatography was used with tetrahydrofuran solvent and polystyrene standards to determine a weight average molecular weight (mw) of 19,048 g/mol and number average molecular weight (mn) of 4,061 g/mol. Mw and/or mn, as reported herein, was measured, unless otherwise indicated, by gel permeation chromatography using a polystyrene standard according to ASTM D6579-11. This was performed using a WATERS 2695 separation module with a WATERS differential refractometer (RI detector); tetrahydrofuran (THF) was used as the eluent at a flow rate of 1 ml/min, and two plgel mixedc (300×7.5 mm) columns were used for separation at the room temperature. Weight and number average molecular weight of polymeric samples can be measured by gel permeation chromatography relative to linear polystyrene standards of 800 to 900,000 g/mol.

### Test Procedure

Example 1 is a comparative example comprising a non-PTC resin and carbon conductive additives which has a loss of electrical resistance responsive to an external stimulus of heating. Examples 2-7 were performed to illustrate coating compositions comprising PTC resin and carbon conductive additives that achieve an irreversible increase in electrical resistance responsive to an external stimulus of heating compared to comparative coating composition comprising a PTC resin. Each coating composition was prepared by mixing monarch 120 carbon black (conductive additive) with a PTC resin (film-forming resin), a crosslinking agent, and optionally a crosslinking inhibitor of dimethyl ethanolamine (DMEA) at 2000 rpm for 1 minute in a THINKY MIXER (THINKY U.S.A., Inc. Laguna hills, CA). The coating compositions were slot die coated on a polyethylene terephthalate (PET) substrate at a 5 mil thickness. The coating compositions were allowed to dry at ambient temperature for hours to form a dry to the touch coating on each substrate (“sample coupon”).

855 A corner-to-corner electrical resistance of a 4 in.×4 in. Cutout of each sample coupon was measured after curing (initial electrical resistivity). The cutouts were then placed in an oven to heat at 60° C. for 30 minutes, and a corner-to-corner electrical resistance was measured again immediately out of the oven. Then, the corner-to-corner electrical resistances were taken daily as the sample cools at ambient temperature until the percent change day on day was less than 5%,

### Example 1 (Comparative)

Example 1 was a coating composition comprising 13 parts monarch 120 carbon black, parts cymel 303 melamine crosslinking agent (available from ALLNEX USA INC.), and 76 parts of a 40/60 vinyl acetate/vinyl chloride co-polymer (VINNOL H 40/60 available from WACKER CHEMIE AG), which was used to generate a sample coupon as described above. Notably, VINNOL 40/60 is not a PTC resin, and is thus more conductive after heating. For example, Example 1 was measured to have a 7.09 ko initial electrical resistivity and the electrical resistivity of example 1 decreased to 3.53 ko immediately after heating in the oven, a 50% decrease. After one week at ambient temperature the percent change day on day was less than 1% and the electrical resistivity of example 1 was measured to be 3.36 ko, a 53% decrease compared to the initial electrical resistivity. Thus, example 1 proves that the resin in a conductive ink coating composition that does not have PTC characteristics will not become more resistive upon heating.

### Example 2

Example 2 was a coating composition comprising 13 parts monarch 120 carbon black, parts cymel 303 melamine crosslinking agent, and 76 parts of PTC 1 resin, which was used to generate a sample coupon as described above. Example 2 was measured to have a 0.041 MΩ initial electrical resistivity and the electrical resistivity of example 2 increased to 0.469 MΩ immediately after heating in the oven, a 1044% increase. After one week at ambient temperature the percent change day on day was less than 5% and the electrical resistivity of example 2 was measured to be 0.113 MΩ, a 175% increase compared to the initial electrical resistivity. Thus, example 2 was considered to have irreversibly increased electrical resistivity compared to the initial electrical resistivity.

### Example 3

Example 3 was a coating composition comprising 13 parts monarch 120 carbon black, parts cymel 303 melamine crosslinking agent, and 76 parts of PTC 2 resin, which was used to generate a sample coupon as described above. Example 3 was measured to have a 0.0266 MΩ initial electrical resistivity and the electrical resistivity of example 3 increased to 5.15 MΩ immediately after heating in the oven, a 19242% increase. After one week at ambient temperature the percent change day on day was less than 5% and the electrical resistivity of example 3 was measured to be 1.00 MΩ, a 3666% increase compared to the initial electrical resistivity. Thus, example 3 was considered to have irreversibly increased electrical resistivity compared to the initial electrical resistivity.

### Example 4

Example 4 was a coating composition comprising 13 parts monarch 120 carbon black, 22 parts cymel 303 melamine crosslinking agent, and 65 parts of PTC 2 resin, which was used to generate a sample coupon as described above. Example 4 was measured to have a 14.9 MΩ initial electrical resistivity and the electrical resistivity of example 4 increased to 41.41 MΩ immediately after heating in the oven, a 178% increase. After three days at ambient temperature the percent change day on day was less than 5% and the electrical resistivity of example 4 was measured to be 32.87 MΩ, a 120% increase compared to the initial electrical resistivity. Thus, example 4 was considered to have irreversibly increased electrical resistivity compared to the initial electrical resistivity.

### Example 5

Example 5 was a coating composition comprises 13 parts monarch 120 carbon black, 3.67 parts n,n′-carbonyldiimidazole (CDI) crosslinking agent, and 83.33 parts PTC 2 resin, which was used to generate a sample coupon as described above. Example 5 was measured to have a 0.048 MΩ initial electrical resistivity and the electrical resistivity of example 5 increased to 0.179 MΩ immediately after heating in the oven, a 273% increase. After six days at ambient temperature the percent change day on day was less than 5% and the electrical resistivity of example 5 was measured to be 0.09 MΩ, a 87.5% increase compared to the initial electrical resistivity. Thus, example 5 was considered to have irreversibly increased electrical resistivity compared to the initial electrical resistivity.

### Example 6

Example 6 was a coating composition comprising 13 parts monarch 120 carbon black, parts resimene HM-2608 melamine crosslinking agent (available from PREFERE RESINS HOLDING GMBH), and 70 parts of PTC 2 resin, which was used to generate a sample coupon as described above. Example 6 was measured to have a 0.482 MΩ initial electrical resistivity and the electrical resistivity of example 6 increased to 0.933 MΩ immediately after heating in the oven, a 93.5% increase. Example 6 did not achieve any permanent increase in resistance 1 week after heating. It was observed that the coating composition was substantially crosslinked when measuring the initial resistivity as the HM-2608 melamine crosslinking agent was not prevented from crosslinking until the heating was applied.

### Example 7

Example 7 was a coating composition comprising 13 parts monarch 120 carbon black, parts resimene HM-2608 melamine crosslinking agent, 0.01 parts DMEA (100% effective neutralization of crosslinking agent), and 70 parts of PTC 2 resin, which was used to generate a sample coupon as described above. Example 7 was measured to have a 0.034 MΩ initial electrical resistivity and a OWRTL of 2.9 dB as measured with an RMS-D from PERISENS as described above. The electrical resistivity of example 7 increased to 48.44 MΩ immediately after heating in the oven, a 142203% increase. After ten days at ambient temperature the percent change day on day was less than 5% and the electrical resistivity of example 7 was measured to be 1.63 MΩ, a 4676% increase compared to the initial electrical resistivity and had a OWRTL of 2.2 dB, a reduction of 0.7 db in OWRTL. Thus, example 7 was considered to have irreversibly increased electrical resistivity compared to the initial electrical resistivity.

Whereas particular examples have been described above for purposes of illustration, other coating compositions according to the present disclosure can achieve an irreversible increase in electrical conductivity and other external stimuli can be used.

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements.

Whereas particular examples have been described above for purposes of illustration, it will be evident to those skilled in the art that numerous variations of the details of the present disclosure may be made without departing from the disclosure as defined in the appended claims.

The term “average” as used herein means a “mean” of any variable, x, such as wavelength, diameter, lateral size, thickness, and so forth, is calculated by the equation: average=(1/n)σxᵢ, where N values of the variable x are being averaged, such that i=1 to N, and oxᵢ=x₁+x₂+ . . . +xₙ.

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The inventors and the applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statementₛ, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the 985 written description, sufficiency of description, and added matter requirements.

In addition to the foregoing, the present disclosure can be described in terms of various configurations and alternative configurations for providing particular physical properties, characteristics, compositions, and/or results. For example, at least one configuration of the present disclosure includes a coating composition which may include a film-forming resin; and a conductive additive; wherein a coating formed from the coating composition has an irreversible increase in resistivity of at least 20%, as measured with an ohm meter probe prior to and after exposing the coating to an external stimulus.

In additional or alternative configurations, the measured, irreversible increase in resistivity is at least 50%. In additional or alternative configurations, the conductive additive comprises carbon, a conductive metal, a conductive polymer, or a combination thereof. In additional or alternative configurations, the conductive additive comprises carbon black, carbon fibers, graphene, or a combination thereof. In additional or alternative configurations the conductive additive comprises carbon nanotubes configured to degrade responsive to the external stimulus, and the conductive additive comprises a conductive polymer configured to degrade responsive to the external stimulus, or a combination thereof. In additional or alternative configurations, the external stimulus comprises any one of heat, actinic radiation, or a combination thereof. In additional or alternative configurations, the external stimulus comprises any one of electrical current, application of a chemical agent, or a combination thereof. In additional or alternative configurations, the external stimulus comprises heat to a temperature of at least 30 degrees celsius. In additional or alternative configurations, the film-forming resin comprises a positive temperature coefficient resin that changes its physical properties responsive to the external stimulus.

In additional or alternative configurations, the film-forming resin comprises an at least 10 carbon chain backbone. In additional or alternative configurations, the film-forming resin comprises a hydroxyl functional group and/or a carboxylic acid functional group. In additional or alternative configurations, the film-forming resin further comprises a crosslinking agent. In additional or alternative configurations, the film-forming resin further comprises a crosslink inhibitor. In additional or alternative configurations, the crosslink inhibitor is at least partially deactivated, responsive to the external stimulus. In additional or alternative configurations, the crosslinking agent comprises an aminoplast, a polyisocyanate, a polyepoxide, a beta-hydroxyalkylamide, a polyacid, an anhydride, an organometallic acid-functional material, a polyamine, a polyamide, or a combination thereof. In additional or alternative configurations, wherein the crosslink inhibitor comprises a solvent, an acid, a base, a metal chelator, or a combination thereof.

In additional or alternative configurations, the crosslink inhibitor comprises dimethylethanolamine, propionic acid, acetic acid, an amine, ammonia, acetylacetone, a thiol, or a combination thereof. In additional or alternative configurations, the coating substantially maintains cohesion after application of the external stimulus. In additional or alternative configurations, the coating substantially maintains initial (i) aesthetic properties, and (ii) mechanical coating properties with an adjacent layer after application of the external stimulus. In additional or alternative configurations, the coating can transmit 10% or more of electromagnetic radiation comprising a frequency of 1 GHz to 300 GHz, through the coating after the external stimulus compared to the transmission of electromagnetic radiation through the coating prior to the external stimulus.

In additional or alternative configurations, after exposure to the external stimulus, the coating composition can further include: a non-conductive coating or non-conductive film; wherein the non-conductive coating or non-conductive film transmits 20% or greater of electromagnetic radiation comprising a frequency of 1 GHz to 300 GHz through the coating or film. In additional or alternative configurations, the non-conductive coating or non-conductive film comprises a CIELAB AE of 15 or less compared to the coating or film before the external stimulus is applied using a multi-angle spectrophotometer with D65 illumination and 10° observer. In additional or alternative configurations, the non-conductive coating or non-conductive film has a dry film thickness in a range of from 0.2 microns to 1000 microns.

In addition to the foregoing, the present disclosure can include an article of manufacture that includes a substrate; and a non-conductive coating or non-conductive film formed over the substrate, wherein: the non-conductive coating or film comprises a film-forming resin and a conductive additive to which an external stimulus has applied; the non-conductive coating or non-conductive film transmits 20% or greater of electromagnetic radiation comprising a frequency of 1 GHz to 300 GHz through the coating or film. In additional or alternative configurations, the non-conductive coating or film comprises a CIELAB AE of 15 or less compared to the coating or film before the external stimulus was applied using a multi-angle spectrophotometer with D65 illumination and 10° observer. In additional or alternative configurations, the non-conductive coating or film has a dry film thickness in a range of from 0.2 microns to 1000 microns. In additional or alternative configurations, the substrate comprises a bumper fascia, a mirror housing, a radar enclosure, or a combination thereof. In additional or alternative configurations, the substrate is radar transmissive. In additional or alternative configurations, the non-conductive coating or film comprises a pretreatment layer, an adhesion promoter layer, a basecoat layer, a mid-coat layer, a topcoat layer, a primer layer, or combinations thereof.

Still further, another configuration of the present disclosure may include a method for making an article, where the method may include: applying a coating composition over a substrate, wherein the coating comprises a film-forming resin and a conductive additive; curing and/or drying the coating composition on the substrate to form a self-supporting coating; and subjecting the self-supporting coating to an external stimulus to form a coating layer on the substrate; wherein the coating layer: is non-conductive and transmits 20% or greater of electromagnetic radiation comprising a frequency of 1 GHz to 300 GHz through the non-conductive coating.

In additional or alternative configurations, the method can further include applying a second coating composition over the self-supporting coating using electrodeposition, electrostatic assisted application, or a combination thereof. In additional or alternative configurations, subjecting the self-supporting coating to the external stimulus comprises one or more of: heating the self-supporting coating; and applying a chemical agent to the self-supporting coating. In additional or alternative configurations, the external stimuli further include any one or more of: subjecting the self-supporting coating to particle radiation; applying electromagnetic radiation to the self-supporting coating; and applying an electrical current to the self-supporting coating. In additional or alternative configurations, application of the external stimulus causes the coating composition to have an improvement in radar transmission loss by at least 10% in an electromagnetic frequency range of from 1 GHz to 300 GHz.

In still further additional or alternative configurations, the present disclosure can include a coating composition, which may include: a positive temperature coefficient resin; an electrically conductive additive; and a crosslinking agent. In additional or alternative configurations, the positive temperature coefficient resin may include a polyester polymer that includes the following chemical structure:

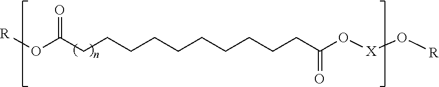

where n≥1, X is incorporated through any polyol, and R is any component, including H, and/or the positive temperature coefficient resin include a polyester polymer that includes the following chemical structure:

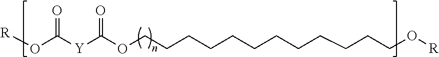

where n≥1, Y is derived from any polyacid (including polyacid halide), polyester, or the like, and R is any component, including H. In additional or alternative configurations, a coating formed from the coating composition has an irreversible increase in resistivity of at least 20%, as measured with an ohm meter probe prior to and after exposing the coating to an external stimulus, such as described in the specification as corner-to-corner electrical resistance prior to and after exposing the coating to an external stimulus. In additional or alternative configurations, the crosslinking agent comprises an aminoplast, a polyisocyanate (including blocked isocyanates), a polyepoxide, a beta-hydroxyalkylamide, a polyacid, an anhydride, an organometallic acid-functional material, a polyamine, a polyamide, or a combination thereof.

While the present disclosure provides descriptions of various specific aspects for the purpose of illustrating various aspects of the present disclosure and/or its potential applications, it is understood that variations and modifications will occur to those skilled in the art.

Accordingly, the present disclosure herein should be understood to be at least as broad as claimed and not as more narrowly defined by particular illustrative aspects provided herein.

20. A coating composition comprising:
a film-forming resin; and
a conductive additive, the conductive additive being electrically conductive;
wherein a coating formed from the coating composition has an irreversible increase in resistivity of at least 20%, as measured with an ohm meter probe prior to and after exposing the coating to an external stimulus.

21. The coating composition of claim 20, wherein the measured, irreversible increase in resistivity is at least 50%.

22. The coating composition of claim 20, wherein the conductive additive comprises carbon, a conductive metal, a conductive polymer, or a combination thereof.

23. The coating composition of claim 20, wherein the conductive additive comprises carbon black, carbon fibers, graphene, or a combination thereof.

24. The coating composition of claim 20, wherein:
the conductive additive comprises carbon nanotubes configured to degrade responsive to the external stimulus, and
the conductive additive comprises a conductive polymer configured to degrade responsive to the external stimulus, or a combination thereof.

25. The coating composition of claim 20, wherein the external stimulus comprises any one of heat, actinic radiation, or a combination thereof.

26. The coating composition of claim 20, wherein the external stimulus comprises any one of electrical current, application of a chemical agent, or a combination thereof.

27. The coating composition of claim 20, wherein the film-forming resin comprises a positive temperature coefficient resin that changes its physical properties responsive to the external stimulus.

28. The coating composition of claim 20, further comprising:
a crosslink inhibitor;
wherein the crosslink inhibitor is at least partially deactivated, responsive to the external stimulus.

29. The coating composition of claim 20, wherein, after application of the external stimulus, the coating substantially maintains any one or all of:
(i) cohesion after application of the external stimulus;
(ii) initial aesthetic properties, and
(iii) mechanical coating properties with an adjacent layer after application of the external stimulus.

30. The coating composition of claim 20, wherein the coating can transmit 10% or more of electromagnetic radiation comprising a frequency of 1 GHz to 300 GHz, through the coating after the external stimulus compared to the transmission of electromagnetic radiation through the coating prior to the external stimulus.

31. The coating composition of claim 20, wherein, after exposure to the external stimulus, the coating composition comprises:
a non-conductive coating or non-conductive film;
wherein the non-conductive coating or non-conductive film transmits 20% or greater of electromagnetic radiation comprising a frequency of 1 GHz to 300 GHz through the coating or film.

32. An article comprising:
a substrate; and
a non-conductive coating or non-conductive film formed over the substrate, wherein:
the non-conductive coating or film comprises a film-forming resin and a conductive additive to which an external stimulus has been applied, the conductive additive being electrically conductive;
the non-conductive coating or non-conductive film transmits 20% or greater of electromagnetic radiation comprising a frequency of 1 GHz to 300 GHz through the coating or film.

33. The article of claim 32, wherein the substrate comprises a bumper fascia, a mirror housing, a radar enclosure, or a combination thereof.

34. A method for making an article, the method comprising:
curing and/or drying a coating composition on a substrate to form a self-supporting coating, wherein the coating composition comprises a film-forming resin and a conductive additive; and
subjecting the self-supporting coating to an external stimulus to form a coating layer on the substrate;
wherein, as a result of the external stimulus, the coating layer:
is non-conductive, having an electrical resistivity of at least 1 ohm×cm as measured with a four-point ohm meter probe; and
transmits 20% or greater of electromagnetic radiation comprising a frequency of 1 GHz to 300 GHz through the non-conductive coating.

35. The method of claim 34, further comprising:
applying a second coating composition over the self-supporting coating using electrodeposition, electrostatic assisted application, or a combination thereof.

36. The method of claim 34, wherein subjecting the self-supporting coating to the external stimulus comprises one or more of:
heating the self-supporting coating; and
applying a chemical agent to the self-supporting coating.

37. The method of claim 34, wherein the external stimuli include any one or more of:
subjecting the self-supporting coating to particle radiation;
applying electromagnetic radiation to the self-supporting coating; and
applying an electrical current to the self-supporting coating.

38. The method of claim 34, wherein application of the external stimulus causes the coating composition to have an improvement in radar transmission loss by at least 10% in an electromagnetic frequency range of from 1 GHz to 300 GHz.
